(19) United States
(12) Patent Application Publication
(10) Pub. No.: US 2026/0189623 A1
(43) Pub. Date: Jul. 2, 2026

(54) INFORMATION PROCESSING APPARATUS, SYSTEM, VEHICLE, NON-TRANSITORY COMPUTER READABLE MEDIUM, AND AGREEMENT CONFIRMATION METHOD

(71) Applicant: TOYOTA JIDOSHA KABUSHIKI KAISHA, Toyota-shi (JP)

(72) Inventor: Ayako Takizaki, Okazaki-shi (JP)

(73) Assignee: TOYOTA JIDOSHA KABUSHIKI KAISHA, Toyota-shi (JP)

(21) Appl. No.: 19/424,622

(22) Filed: Dec. 18, 2025

(30) Foreign Application Priority Data
Dec. 27, 2024 (JP) 2024-232806

(51) Int. Cl. H04L 67/12; B60K 35/29

(52) U.S. Cl. CPC H04L 67/12; B60K 35/29; B60K 2360/589

(57) ABSTRACT

An information processing apparatus includes a communication interface that communicates with a server apparatus, and a controller that receives, via the communication interface from the server apparatus, agreement information indicating whether a user on board a vehicle has agreed in advance to the terms of use on a terminal apparatus associated with the user, upon determining, based on the received agreement information, that the user has not agreed to the terms of use on the terminal apparatus, asks the user whether to temporarily agree to the terms of use, via an output device mounted in the vehicle, and upon acquiring, from the user via an input device mounted in the vehicle, a response indicating temporary agreement to the terms of use, transmits data collected in the vehicle to the server apparatus via the communication interface within a limited period only.

### CROSS-REFERENCE TO RELATED APPLICATION

This application claims priority to Japanese Patent Application No. 2024-232806 filed on December 27, 2024, the entire contents of which are incorporated herein by reference.

### TECHNICAL FIELD

The present disclosure relates to an information processing apparatus, a system, a vehicle, a program, and an agreement confirmation method.

### BACKGROUND

Patent Literature (PTL) 1 discloses an apparatus that displays a screen on which a user on board a vehicle selects whether to agree to information provision, and transmits information outside the vehicle when the user has agreed.

### CITATION LIST

### Patent Literature

PTL 1: JP 2020-135813 A

### SUMMARY

It is conceivable to agree to the terms of use of an external transmission function on a terminal apparatus such as a smartphone. However, when a user cannot agree to the terms of use on a terminal apparatus, for the reason that there is no time to give formal agreement, the user does not have a terminal apparatus at hand, or the like, the user cannot utilize the external transmission function, which is disadvantageous to the user.

It would be helpful to enable a user to utilize an external transmission function even when the user cannot agree to the terms of use on a terminal apparatus.

An information processing apparatus according to the present disclosure includes:

a communication interface configured to communicate with a server apparatus; and

a controller configured to:

receive, via the communication interface from the server apparatus, agreement information indicating whether a user on board a vehicle has agreed in advance to the terms of use on a terminal apparatus associated with the user;

upon determining, based on the received agreement information, that the user has not agreed to the terms of use on the terminal apparatus, ask the user whether to temporarily agree to the terms of use, via an output device mounted in the vehicle; and

upon acquiring, from the user via an input device mounted in the vehicle, a response indicating temporary agreement to the terms of use, transmit data collected in the vehicle to the server apparatus via the communication interface within a limited period only.

An agreement confirmation method according to the present disclosure includes:

receiving, via a network from a server apparatus, agreement information indicating whether a user on board a vehicle has agreed in advance to the terms of use on a terminal apparatus associated with the user;

upon determining, based on the received agreement information, that the user has not agreed to the terms of use on the terminal apparatus, asking the user whether to temporarily agree to the terms of use, via an output device mounted in the vehicle; and

upon acquiring, from the user via an input device mounted in the vehicle, a response indicating temporary agreement to the terms of use, transmitting data collected in the vehicle to the server apparatus via the network within a limited period only.

The present disclosure enables a user to utilize an external transmission function even when the user cannot agree to the terms of use on a terminal apparatus. This improves convenience.

### BRIEF DESCRIPTION OF THE DRAWINGS

In the accompanying drawings:

FIG. 1 is a block diagram illustrating a configuration of a system according to an embodiment of the present disclosure;

FIG. 2 is a diagram illustrating an example of an information processing apparatus mounted in a vehicle, according to the embodiment of the present disclosure;

FIG. 3 is a block diagram illustrating the connection between the information processing apparatus and in-vehicle devices, according to the embodiment of the present disclosure;

FIG. 4 is a diagram illustrating a comparative example;

FIG. 5 is a diagram illustrating a practical example; and

FIG. 6 is a flowchart illustrating operations of the information processing apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified as appropriate.

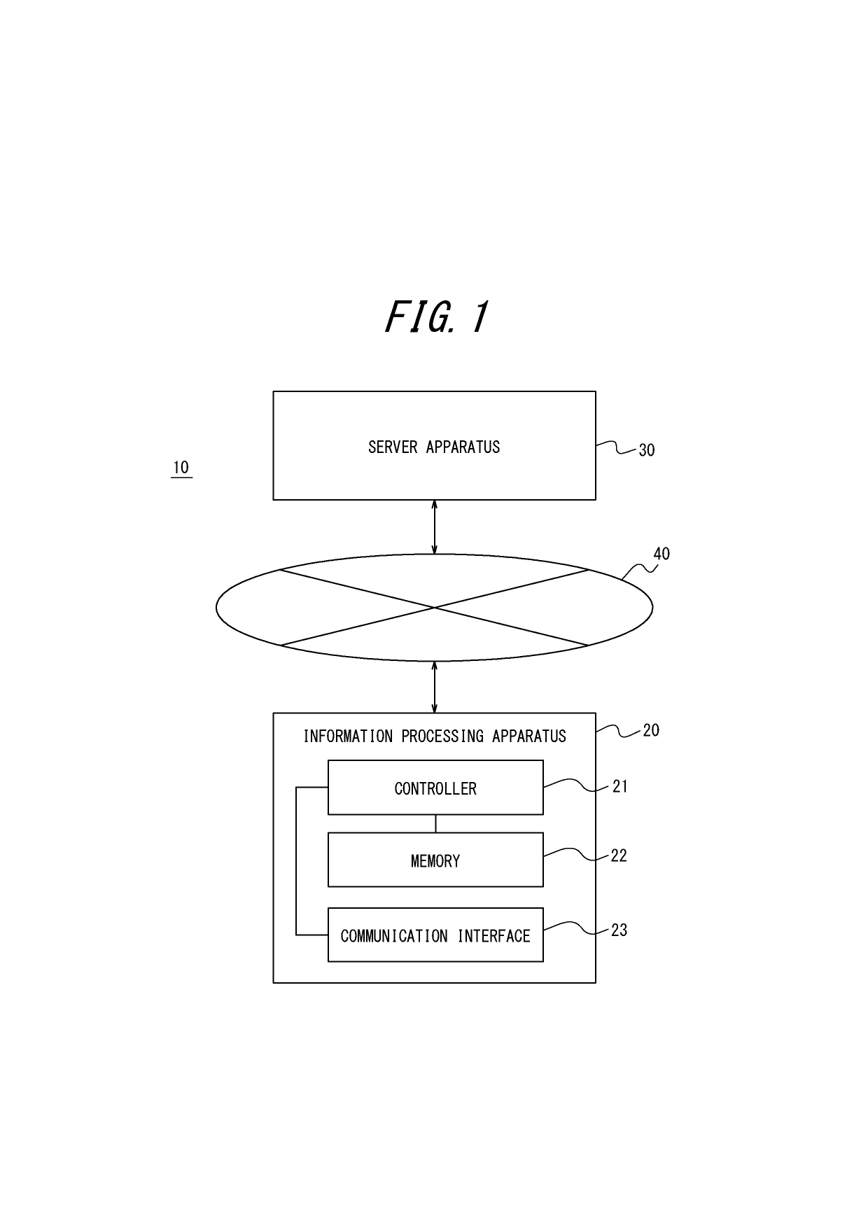

A configuration of a system 10 according to the present embodiment will be described with reference to FIG. 1.

The system 10 according to the present embodiment includes an information processing apparatus 20 and a server apparatus 30. The information processing apparatus 20 can communicate with the server apparatus 30 via a network 40.

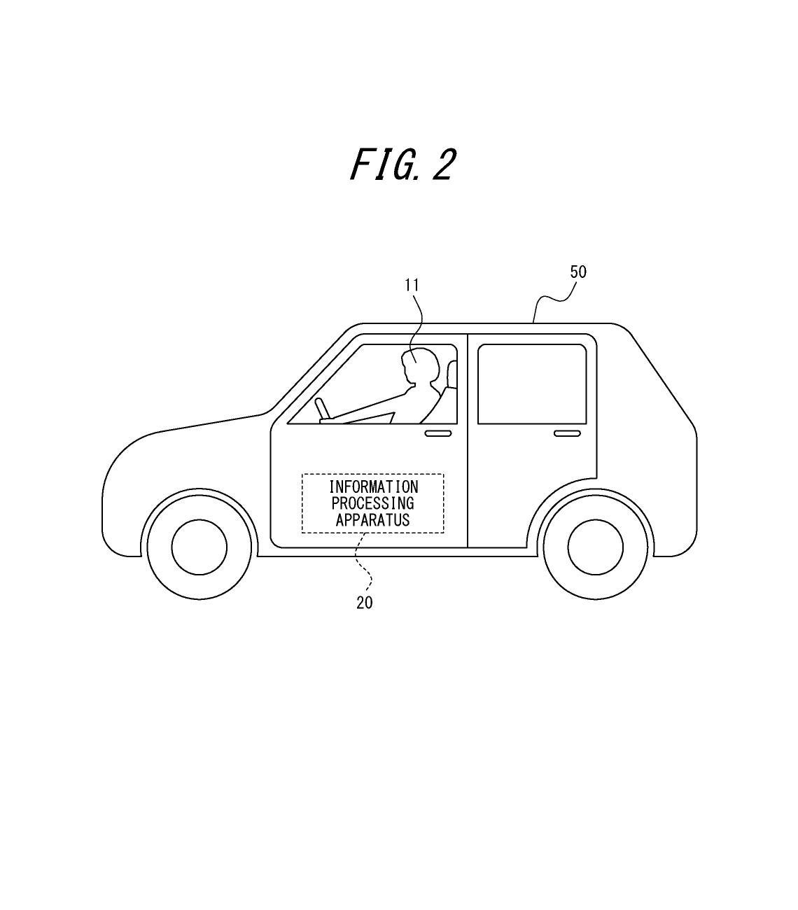

The information processing apparatus 20 may be a general purpose computer such as a PC, a server computer such as a cloud server, or a dedicated computer. The term "PC" is an abbreviation of personal computer. As illustrated in FIG. 2, in the present embodiment, the information processing apparatus 20 is mounted in a vehicle 50. As a variation, the information processing apparatus 20 may be installed in a location away from the vehicle 50, such as a data center, as long as the information processing apparatus 20 can communicate with various devices mounted in the vehicle 50.

The vehicle 50 is, for example, any type of automobile such as a gasoline vehicle, a diesel vehicle, a hydrogen vehicle, an HEV, a PHEV, a BEV, or an FCEV. The term "HEV" is an abbreviation of hybrid electric vehicle. The term "PHEV" is an abbreviation of plug-in hybrid electric vehicle. The term "BEV" is an abbreviation of battery electric vehicle. The term "FCEV" is an abbreviation of fuel cell electric vehicle. The vehicle 50 is driven by a user 11 in the present embodiment, but the driving may be automated at any level. The automation level is, for example, any one of Level 1 to Level 5 according to the level classification defined by SAE. The name "SAE" is an abbreviation of Society of Automotive Engineers. The vehicle 50 may be a MaaS-dedicated vehicle. The term "MaaS" is an abbreviation of Mobility as a Service.

The server apparatus 30 is a server computer such as a cloud server. The server apparatus 30 is installed in a facility such as a data center.

The network 40 includes the Internet, at least one WAN, at least one MAN, or any combination thereof. The term "WAN" is an abbreviation of wide area network. The term "MAN" is an abbreviation of metropolitan area network. The network 40 may include at least one wireless network, at least one optical network, or any combination thereof. The wireless network is, for example, an ad hoc network, a cellular network, a wireless LAN, a satellite communication network, or a terrestrial microwave network. The term "LAN" is an abbreviation of local area network.

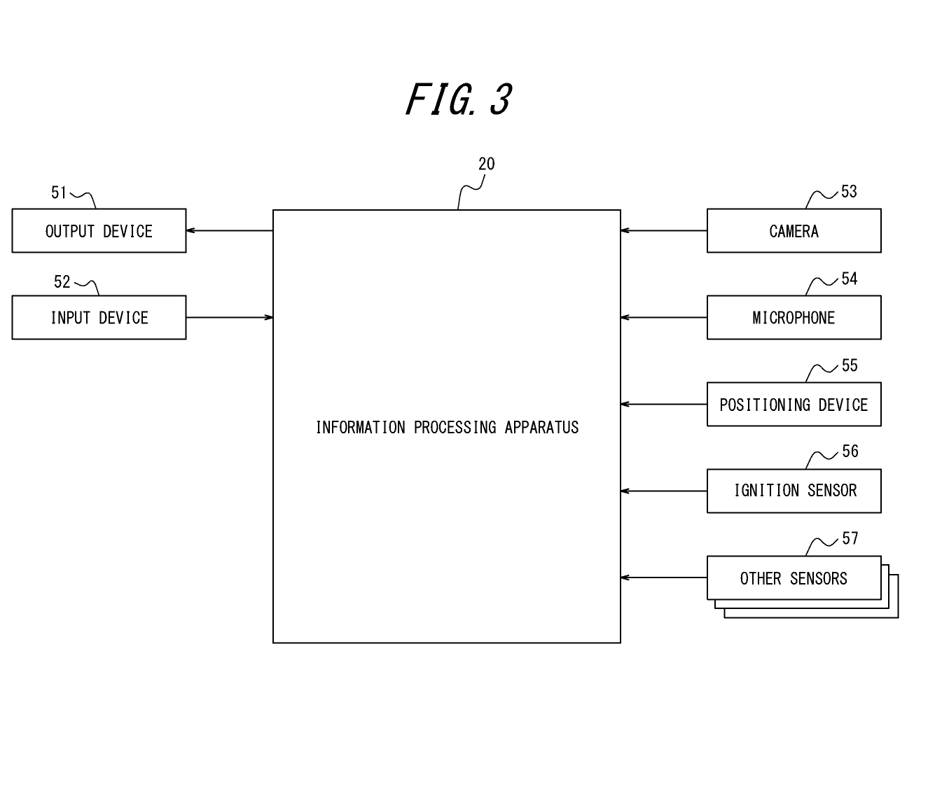

As illustrated in FIG. 3, in the present embodiment, the information processing apparatus 20 is connected to various devices mounted in the vehicle 50, such as an output device 51, an input device 52, a camera 53, a microphone 54, a positioning device 55, an ignition sensor 56, and one or more other sensors 57. As interfaces for connection with the various devices, interfaces compliant with standards such as USB, HDMI^{®} (HDMI is a registered trademark in Japan, other countries, or both), or Bluetooth^{®} (Bluetooth is a registered trademark in Japan, other countries, or both) can be used. The term "USB" is an abbreviation of Universal Serial Bus. The term "HDMI^{®}" is an abbreviation of High-Definition Multimedia Interface. As a variation, the information processing apparatus 20 may have one or more devices, among the various devices mounted in the vehicle 50.

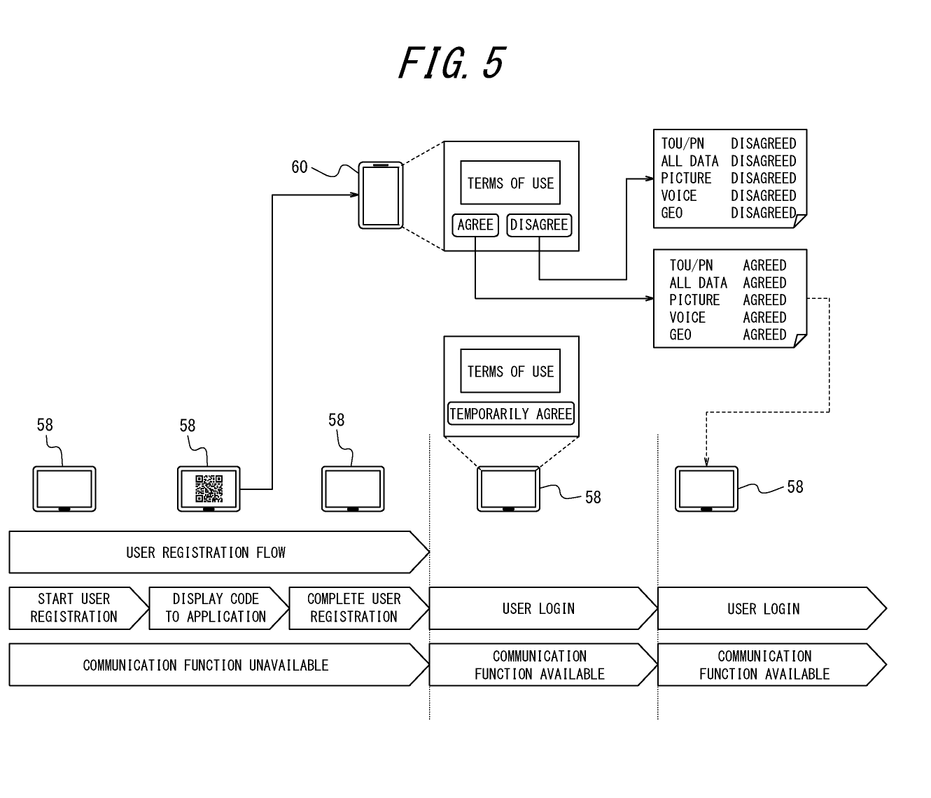

The output device 51 is, for example, a display 58 as illustrated in FIG. 5, or a speaker. The display 58 is, for example, an LCD or an organic EL display. The term "LCD" is an abbreviation of liquid crystal display. The term "EL" is an abbreviation of electro luminescent. The display 58 may be a display audio. The output device 51 outputs information obtained by operations of the information processing apparatus 20.

The input device 52 is, for example, a physical key, a capacitive key, a pointing device, or a touch screen integrally provided with the display 58. The camera 53, microphone 54, or both may also serve as the input device 52. The input device 52 accepts an operation for inputting information to be used for operations of the information processing apparatus 20.

The camera 53 is, for example, a visible light camera or a depth camera. The camera 53 captures images of the interior, exterior, or both of the vehicle 50 as a type of data that can be transmitted externally.

The microphone 54 collects audio from the interior, exterior, or both of the vehicle 50 as a type of data that can be transmitted externally.

The positioning device 55 is, for example, a GNSS receiver. The term "GNSS" is an abbreviation of global navigation satellite system. GNSS is, for example, GPS, QZSS, BDS, GLONASS, or Galileo. The term "GPS" is an abbreviation of Global Positioning System. The term "QZSS" is an abbreviation of Quasi-Zenith Satellite System. QZSS satellites are called quasi-zenith satellites. The term "BDS" is an abbreviation of BeiDou Navigation Satellite System. The term "GLONASS" is an abbreviation of Global Navigation Satellite System. The positioning device 55 measures the coordinates of the vehicle 50, that is, the vehicle position, as a type of data that can be transmitted externally.

The ignition sensor 56 detects the state of an ignition of the vehicle 50. The ignition sensor 56 outputs a signal indicating the detected state.

The other sensors 57 include, for example, a vehicle speed sensor, an acceleration sensor, a gyro, a human detection sensor, or a door open/close sensor. The other sensors 57 observe various events in different parts of the vehicle 50 to acquire the observation results as a type of data that can be transmitted externally.

An outline of the present embodiment will be described with reference to FIG. 1.

When the user 11 gets into the vehicle 50, the information processing apparatus 20 receives agreement information from the server apparatus 30 via the network 40. The agreement information is information indicating whether the user 11 has agreed in advance to the terms of use on a terminal apparatus 60, as illustrated in FIG. 5, associated with the user 11. The terminal apparatus 60 is, for example, a smartphone or tablet. Upon determining, based on the received agreement information, that the user 11 has not agreed to the terms of use on the terminal apparatus 60, the information processing apparatus 20 asks the user 11 via the output device 51 mounted in the vehicle 50 whether to temporarily agree to the terms of use. Upon acquiring, from the user 11 via the input device 52 mounted in the vehicle 50, a response indicating that the user 11 temporarily agrees to the terms of use, the information processing apparatus 20 transmits data collected in the vehicle 50 to the server apparatus 30 via the network 40 within a limited period only. The limited period is, for example, the period until the ignition of the vehicle 50 is turned off, or the period corresponding to one trip of the vehicle 50. The trip refers to movement from a departure point to an arrival point for a single purpose.

According to the present embodiment, even when the user 11 cannot agree to the terms of use on the terminal apparatus 60, for the reason that there is no time to give formal agreement, the user 11 does not have the terminal apparatus 60 at hand, or the like, the user 11 can utilize an external transmission function. This improves convenience.

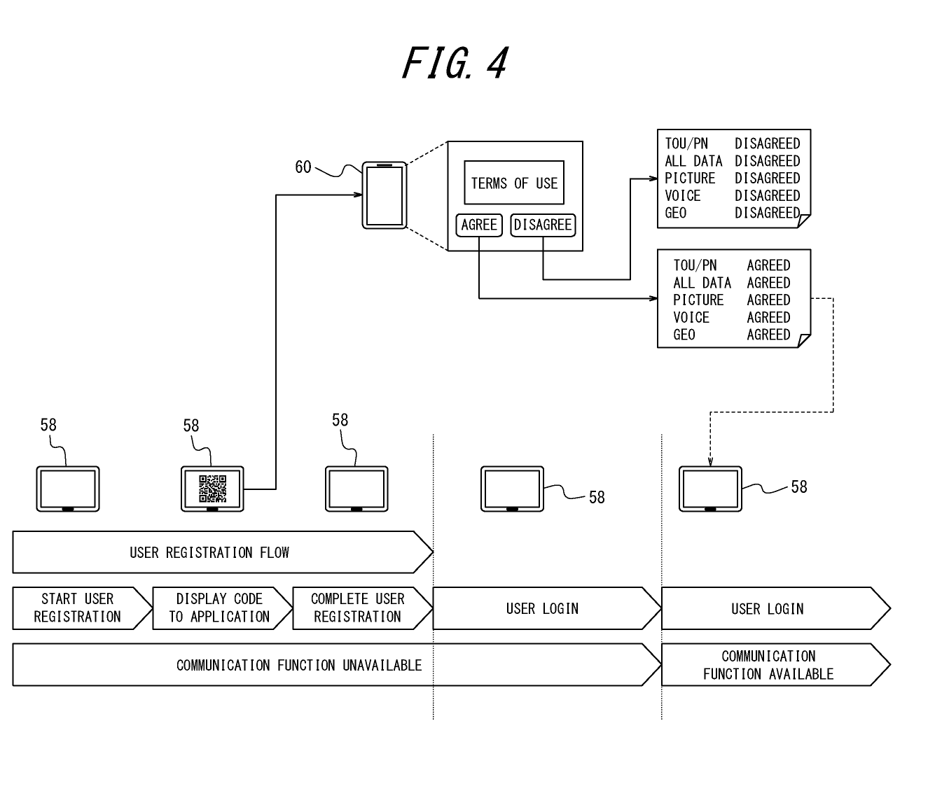

A comparative example will be described with reference to FIG. 4.

In this comparative example, user registration is performed via the display 58 mounted in the vehicle 50. In the course of the user registration, a two-dimensional code is displayed on the display 58. When an application for agreement to the terms is launched on the terminal apparatus 60 and the two-dimensional code is read by the terminal apparatus 60, the terms of use for a communication function for external transmission and a user interface for selecting "Agree" or "Disagree" are displayed on the terminal apparatus 60. When "Agree" is selected, the statuses of "Agreed" are recorded in the server apparatus 30 for the terms of use and the external transmission of all data, images, audio, and vehicle position. When "Disagree" is selected, the statuses of "Disagreed" are recorded in the server apparatus 30 for the terms of use and the external transmission of all data, images, audio, and vehicle position. Even when the user 11 agrees to the terms of use, the user 11 may be able to select not to agree to the external transmission of images, audio, vehicle position, or any combination of these. For example, "Agreed" may be recorded in the server apparatus 30 for the terms of use and the external transmission of all data, images, and audio, while "Disagreed" may be recorded in the server apparatus 30 for the external transmission of vehicle position. In such a case, agreement has been obtained for the external transmission of all data collected in the vehicle 50, excluding vehicle position.

After the user registration is completed, the status regarding agreement to the terms is notified from the server apparatus 30 to the vehicle 50 at the time of user login. When "Agreed" is recorded in the server apparatus 30 for at least the terms of use, the communication function for external transmission is available. When "Disagreed" is recorded in the server apparatus 30 for the terms of use, the communication function for external transmission is unavailable, but this does not disadvantage the user 11 because this is in line with the intention of the user 11. On the other hand, when agreement to the terms is not made on the terminal apparatus 60 and "Agreed" is not recorded in the server apparatus 30 for the terms of use, the user 11 is unable to use the communication function for external transmission despite wanting to, which disadvantages the user 11.

As described above, in this comparative example, the user registration and agreement to the terms are performed on separate terminals. In a state in which the user 11 has been registered but has not completed agreement to the terms, the external transmission of data cannot be performed, which is inconvenient for the user 11.

A practical example will be described with reference to FIG. 5.

In this example, similar to the comparative example illustrated in FIG. 4, user registration is performed via the display 58. The point that agreement to the terms is made on the terminal apparatus 60 is also the same as in the comparative example, so an explanation is omitted.

After the user registration is completed, the status regarding agreement to the terms is notified from the server apparatus 30 to the information processing apparatus 20 at the time of user login. Similar to the comparative example, when "Agreed" is recorded in the server apparatus 30 for at least the terms of use, the communication function for external transmission is available. When "Disagreed" is recorded in the server apparatus 30 for the terms of use, the communication function for external transmission is unavailable. In this example, in contrast to the comparative example, when agreement to the terms has not been carried out on the terminal apparatus 60 and "Agreed" is not recorded in the server apparatus 30 for the terms of use, the terms of use for the communication function for external transmission and a user interface for selecting "Temporarily Agree" are displayed on the display 58. When "Temporarily Agree" is selected, the communication function for external transmission becomes temporarily available. For example, the state in which the communication function is temporarily available ends when the ignition is turned off. That is, when the ignition is turned off, the settings of temporary external transmission is released.

As described above, in this example, even in a state in which the user 11 has been registered but has not completed agreement to the terms, external transmission of data becomes possible. This improves convenience.

The server apparatus 30 may log a history of agreement to the terms. When it is necessary to re-obtain agreement to the terms each time the terms of use are updated, the server apparatus 30 may log a history of agreement to the terms for each version of the terms of use. When the terms of use are updated, the settings before the update may be carried over for the external transmission of one or some types of data, among images, audio, and vehicle position, unless there is an impact on the external transmission of that types of data.

A configuration of the information processing apparatus 20 according to the present embodiment will be described with reference to FIG. 1.

The information processing apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term "CPU" is an abbreviation of central processing unit. The term "GPU" is an abbreviation of graphics processing unit. The programmable circuit is, for example, an FPGA. The term "FPGA" is an abbreviation of field-programmable gate array. The dedicated circuit is, for example, an ASIC. The term "ASIC" is an abbreviation of application specific integrated circuit. The controller 21 executes processes related to operations of the information processing apparatus 20 while controlling components of the information processing apparatus 20.

The memory 22 includes at least one semiconductor memory, at least one magnetic memory, at least one optical memory, or any combination thereof. The semiconductor memory is, for example, RAM, ROM, or flash memory. The term "RAM" is an abbreviation of random access memory. The term "ROM" is an abbreviation of read only memory. The RAM is, for example, SRAM or DRAM. The term "SRAM" is an abbreviation of static random access memory. The term "DRAM" is an abbreviation of dynamic random access memory. The ROM is, for example, EEPROM. The term "EEPROM" is an abbreviation of electrically erasable programmable read only memory. The flash memory is, for example, SSD. The term "SSD" is an abbreviation of solid-state drive. The magnetic memory is, for example, HDD. The term "HDD" is an abbreviation of hard disk drive. The memory 22 functions as, for example, a main memory, an auxiliary memory, or a cache memory. The memory 22 stores information to be used for operations of the information processing apparatus 20 and information obtained by operations of the information processing apparatus 20.

The communication interface 23 includes at least one communication module. The communication module is, for example, a module compatible with a mobile communication standard such as LTE, the 4G standard, or the 5G standard, or a wireless LAN communication standard such as IEEE 802.11. The term "LTE" is an abbreviation of Long Term Evolution. The term "4G" is an abbreviation of 4th generation. The term "5G" is an abbreviation of 5th generation. The name "IEEE" is an abbreviation of Institute of Electrical and Electronics Engineers. The communication interface 23 communicates with the server apparatus 30. The communication interface 23 receives information to be used for operations of the information processing apparatus 20, and transmits information obtained by operations of the information processing apparatus 20.

The functions of the information processing apparatus 20 are realized by execution of a program according to the present embodiment by a processor serving as the controller 21. That is, the functions of the information processing apparatus 20 are realized by software. The program causes a computer to execute operations of the information processing apparatus 20, thereby causing the computer to function as the information processing apparatus 20. That is, the computer executes the operations of the information processing apparatus 20 in accordance with the program to thereby function as the information processing apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term "SD" is an abbreviation of Secure Digital. The term "DVD" is an abbreviation of digital versatile disc. The term "CD-ROM" is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time the program is transferred from the server to the computer, sequentially execute processes in accordance with the received program. Instead of transferring the program from the server to the computer, processes may be executed by a so-called ASP type service that realizes functions only by execution instructions and result acquisitions. The term "ASP" is an abbreviation of application service provider. The program encompasses information that is to be used for processing by an electronic computer and is thus equivalent to a program. For example, data that is not a direct command to a computer but has a property that regulates processing of the computer is "equivalent to a program" in this context.

Some or all of the functions of the information processing apparatus 20 may be realized by a programmable circuit or a dedicated circuit serving as the controller 21. That is, some or all of the functions of the information processing apparatus 20 may be realized by hardware.

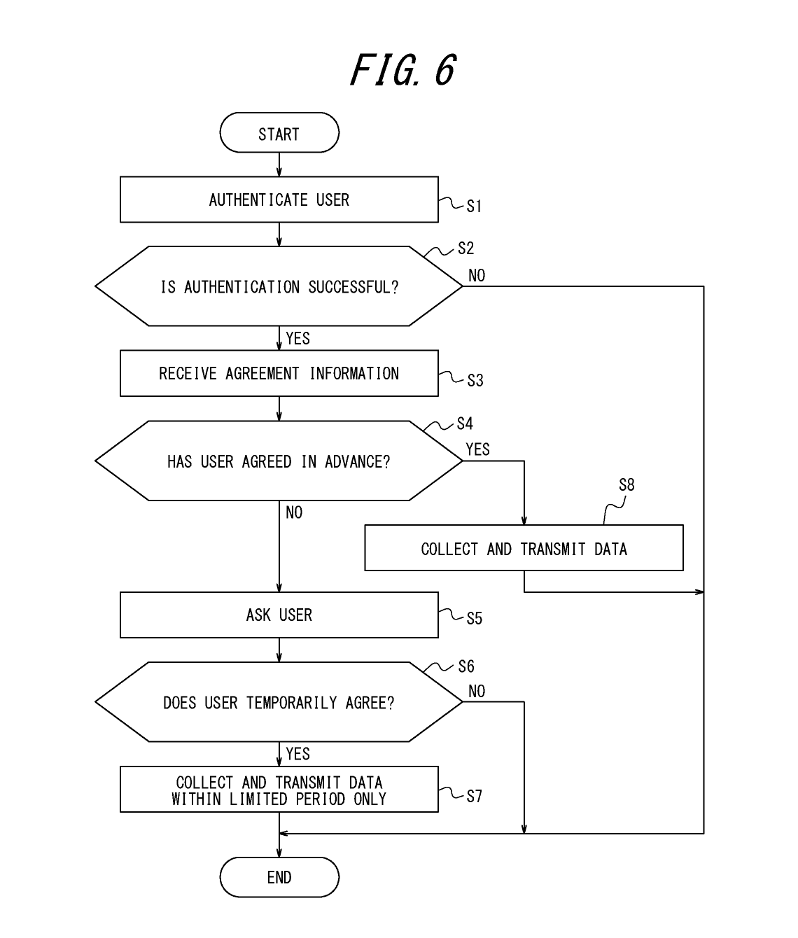

Operations of the information processing apparatus 20 according to the present embodiment will be described with reference to FIG. 6. The operations described below correspond to an agreement confirmation method according to the present embodiment. That is, the agreement confirmation method according to the present embodiment includes steps S1 to S8 illustrated in FIG. 6.

In S1, when the user 11 gets into the vehicle 50, the controller 21 authenticates the user 11 via the input device 52 mounted in the vehicle 50. Specifically, the controller 21 performs authentication using a PIN number or password via a touch screen provided integrally with the display 58. Alternatively, the controller 21 may perform face recognition via the camera 53. Alternatively, the controller 21 may perform voice recognition via the microphone 54. Alternatively, the controller 21 may perform biometric authentication using other methods.

In S2, the controller 21 waits until the authentication in S1 is successful. When the authentication is successful, the step S3 is executed. When the authentication is not successful after a certain period of time, the flow illustrated in FIG. 6 ends.

In S3, the controller 21 receives agreement information from the server apparatus 30 via the communication interface 23. Specifically, the controller 21 transmits a request including an identifier of the user 11 to the server apparatus 30 via the communication interface 23. The controller 21 receives agreement information from the server apparatus 30 in response to the transmitted request.

The agreement information is information indicating whether the user 11 has agreed in advance to the terms of use on the terminal apparatus 60. In the present embodiment, the agreement information is information further indicating whether the user 11 has expressed in advance an intention to disagree to the terms of use on the terminal apparatus 60. That is, the agreement information is information indicating whether the user 11 has agreed in advance to the terms of use on the terminal apparatus 60, whether the user 11 has not agreed to the terms of use on the terminal apparatus 60, or whether the user 11 has expressed in advance an intention to disagree to the terms of use on the terminal apparatus 60. In the example illustrated in FIG. 5, for the terms of use, one of the statuses of "Agreed", "Not Agreed", and "Disagreed" is transmitted as the agreement information from the server apparatus 30.

The agreement information may include prior permission information. The prior permission information is permission information indicating one or more types of data for which external use has been permitted in advance by the user 11 on the terminal apparatus 60. In the example illustrated in FIG. 5, for the external transmission of respective all data, images, audio, and vehicle position, one of the statuses of "Agreed", "Not Agreed", and "Disagreed" is transmitted as the prior permission information from the server apparatus 30.

In S4, the controller 21 determines whether the user 11 has agreed in advance to the terms of use on the terminal apparatus 60 based on the agreement information received in S3. When it is determined that the user 11 has not agreed to the terms of use on the terminal apparatus 60, step S5 is executed. When it is determined that the user 11 has expressed in advance an intention to disagree to the terms of use on the terminal apparatus 60, the flow illustrated in FIG. 6 ends without executing step S5. On the other hand, when it is determined that the user 11 has agreed in advance to the terms of use on the terminal apparatus 60, step S8 is executed.

In S5, the controller 21 asks the user 11 via the output device 51 mounted in the vehicle 50 whether to temporarily agree to the terms of use. Specifically, the controller 21 outputs, via the display 58, a screen asking the user 11 whether to temporarily agree to the terms of use. Alternatively, the controller 21 may output, via a speaker, audio asking the user 11 whether to temporarily agree to the terms of use. In the example illustrated in FIG. 5, a user interface for selecting "Temporarily Agree" is displayed on the display 58 along with the terms of use.

In S6, the controller 21 waits until a response indicating temporary agreement to the terms of use is acquired from the user 11 via the input device 52 mounted in the vehicle 50. In the example illustrated in FIG. 5, selecting "Temporarily Agree" on the display 58 corresponds to acquiring a response from the user 11. When a response is acquired from the user 11, step S6 is executed. When no response is acquired from the user 11 after a certain period of time, the flow illustrated in FIG. 6 ends.

The controller 21 may acquire temporary permission information along with the response via the input device 52. The temporary permission information is permission information indicating one or more types of data for which external use is temporarily permitted by the user 11. In the example illustrated in FIG. 5, "Temporarily Agree" may be individually selected on the display 58 for the external transmission of respective all data, images, audio, and vehicle position.

In S7, the controller 21 transmits data collected in the vehicle 50 to the server apparatus 30 via the communication interface 23 within a limited period only. Specifically, the controller 21 starts monitoring a signal output from the ignition sensor 56 mounted in the vehicle 50, collects one or more types of data among three types of data, i.e., images, audio, and vehicle position until an ignition of the vehicle 50 is detected to be turned off, and transmits that one or more types of data to the server apparatus 30 in real-time via the communication interface 23. The images are acquired via the camera 53 mounted in the vehicle 50. The audio is acquired via the microphone 54 mounted in the vehicle 50. The vehicle position is acquired via the positioning device 55 mounted in the vehicle 50. Instead of or in addition to the one or more types of data among the three types of data, i.e., images, audio, and vehicle position, other types of data acquired via other sensors 57 mounted in the vehicle 50 may be collected.

When the temporary permission information is acquired along with the response in S6, the controller 21 transmits, in S7, one or more types of data that are collected in the vehicle 50 and that are indicated by the temporary permission information, to the server apparatus 30 via the communication interface 23 within the limited period only. For example, when "Temporarily Agree" is selected for the external transmission of all data, images, and audio, and "Temporarily Agree" is not selected for the external transmission of vehicle position, all data excluding vehicle position is collected and transmitted to the server apparatus 30 in real-time until the ignition is turned off.

In S8, the controller 21 transmits data collected in the vehicle 50 to the server apparatus 30 via the communication interface 23, regardless of whether it is within the limited period. Specifically, the controller 21 collects one or more types of data among the three types of data, i.e., images, audio, and vehicle position, without monitoring the signal output from the ignition sensor 56, and transmits that one or more types of data to the server apparatus 30 in real-time via the communication interface 23. Similar to step S7, instead of or in addition to the one or more types of data among the three types of data, i.e., images, audio, and vehicle position, other types of data acquired via the other sensors 57 mounted in the vehicle 50 may be collected.

When the agreement information includes prior permission information, in S8, the controller 21 transmits, to the server apparatus 30 via the communication interface 23, one or more types of data that are collected in the vehicle 50 and are indicated by the prior permission information, regardless of whether it is within the limited period. For example, when "Agreed" is transmitted from the server apparatus 30 for the external transmission of all data, images, and audio, and "Not Agreed" or "Disagreed" is transmitted from the server apparatus 30 for the external transmission of vehicle position, all data excluding vehicle position is collected and transmitted to the server apparatus 30 in real-time.

When the agreement information includes prior permission information, the controller 21 may ask the user 11 via the output device 51 mounted in the vehicle 50 whether to temporarily permit external use of data other than the types indicated by the prior permission information. Specifically, the controller 21 may output, via the display 58, a screen asking the user 11 whether to temporarily permit external use of data other than the types indicated by the prior permission information. Alternatively, the controller 21 may output, via a speaker, audio asking the user 11 whether to temporarily permit external use of data other than the types indicated by the prior permission information.

Upon acquiring, from the user 11 via the input device 52 mounted in the vehicle 50, a response indicating temporary permission for the external use of data other than the types indicated by the prior permission information, the controller 21 transmits data that is collected in the vehicle 50 and that is of a type other than the types indicated by the prior permission information, to the server apparatus 30 via the communication interface 23 within the limited period only. Specifically, the controller 21 starts monitoring the signal output from the ignition sensor 56 mounted in the vehicle 50, collects data other than the types indicated by the prior permission information until the ignition of the vehicle 50 is detected to be turned off, and transmits that data to the server apparatus 30 in real-time via the communication interface 23. For example, when "Agreed" is transmitted from the server apparatus 30 for the external transmission of all data, images, and audio, and "Not Agreed" or "Disagreed" is transmitted from the server apparatus 30 for the external transmission of vehicle position, all data excluding vehicle position is collected and transmitted to the server apparatus 30 in real-time until the ignition is turned off.

When no temporary permission information is acquired along with the response in S6 and the agreement information include no prior permission information, the controller 21 transmits, in S7, data that is collected in the vehicle 50 and that is of more limited types than the data transmitted in S8, to the server apparatus 30 via the communication interface 23 within the limited period only. That is, upon determining that the user 11 has not agreed to the terms of use on the terminal apparatus 60 and acquiring a response from the user 11, the controller 21 may transmit data that is collected in the vehicle 50 and that is of more limited types than data to be transmitted when it is determined that the user 11 has agreed in advance to the terms of use on the terminal apparatus 60, to the server apparatus 30 via the communication interface 23 within the limited period only. For example, in S7, all data excluding vehicle position may be collected and transmitted in real-time to the server apparatus 30 until the ignition is turned off, and in S8, all data including vehicle position may be collected and transmitted in real-time to the server apparatus 30.

In S7 and S8, data collected in the vehicle 50 is transmitted to the server apparatus 30 in association with various additional information. The additional information may include, for example, an identifier of the user 11, an identifier of the vehicle 50, or both, the time at which the data was acquired, the driving state of the vehicle 50 when the data was acquired, or the type of data acquired. The data transmitted to the server apparatus 30 may be utilized by an operator managing the server apparatus 30 along with the additional information. Alternatively, the data transmitted to the server apparatus 30 may be provided secondarily to a third party by the operator managing the server apparatus 30, along with the additional information or with some of the additional information hidden, and may be utilized by that third party.

The present disclosure is not limited to the embodiment described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these examples.

[Appendix 1] An information processing apparatus comprising:

a communication interface configured to communicate with a server apparatus; and

a controller configured to:

upon authenticating a user on board a vehicle via an input device mounted in the vehicle, receive, via the communication interface from the server apparatus, agreement information indicating whether the user has agreed in advance to terms of use on a terminal apparatus associated with the user;

upon determining, based on the received agreement information, that the user has not agreed to the terms of use on the terminal apparatus, output a screen or audio asking the user whether to temporarily agree to the terms of use, via an output device mounted in the vehicle; and

upon acquiring, from the user via the input device, a response indicating temporary agreement to the terms of use, start monitoring a signal output from an ignition sensor mounted in the vehicle, collect one or more types of data among three types of data of images, audio, and vehicle position acquired via a camera, a microphone, and a positioning device mounted in the vehicle, respectively, until detecting that an ignition of the vehicle has been turned off, and transmit the one or more types of data in real-time to the server apparatus via the communication interface.

[Appendix 2] An information processing apparatus comprising:

a communication interface configured to communicate with a server apparatus; and

a controller configured to:

receive, via the communication interface from the server apparatus, agreement information indicating whether a user on board a vehicle has agreed in advance to terms of use on a terminal apparatus associated with the user;

upon determining, based on the received agreement information, that the user has not agreed to the terms of use on the terminal apparatus, ask the user whether to temporarily agree to the terms of use, via an output device mounted in the vehicle; and

upon acquiring, from the user via an input device mounted in the vehicle, a response indicating temporary agreement to the terms of use, transmit data collected in the vehicle to the server apparatus via the communication interface within a limited period only.

[Appendix 3] The information processing apparatus according to appendix 2, wherein the controller is configured to, upon acquiring, via the input device along with the response, permission information indicating a type of data for which external use is temporarily permitted by the user, transmit the type of data that is collected in the vehicle and that is indicated by the permission information, to the server apparatus via the communication interface within the limited period only.

[Appendix 4] The information processing apparatus according to appendix 2 or 3, wherein the controller is configured to, upon determining, based on the agreement information, that the user has agreed in advance to the terms of use on the terminal apparatus, transmit data collected in the vehicle to the server apparatus via the communication interface, regardless of whether it is within the limited period.

[Appendix 5] The information processing apparatus according to appendix 4, wherein

the agreement information includes permission information indicating a type of data for which external use is permitted in advance on the terminal apparatus by the user, and

the controller is configured to, upon determining that the user has agreed in advance to the terms of use on the terminal apparatus, transmit the type of data that is collected in the vehicle and that is indicated by the permission information, to the server apparatus via the communication interface, regardless of whether it is within the limited period.

[Appendix 6] The information processing apparatus according to appendix 5, wherein the controller is configured to:

upon determining that the user has agreed in advance to the terms of use on the terminal apparatus, ask the user via the output device whether to temporarily permit external use of data other than the type indicated by the permission information; and

upon acquiring, from the user via the input device, a response indicating temporary permission of external use of data other than the type indicated by the permission information, transmit data that is collected in the vehicle and that is of a type other than the type indicated by the permission information, to the server apparatus via the communication interface within the limited period only.

[Appendix 7] The information processing apparatus according to any one of appendices 4 to 6, wherein the controller is configured to, upon determining that the user has not agreed to the terms of use on the terminal apparatus and upon acquiring the response from the user, transmit data that is collected in the vehicle and that is of a more limited type than the data to be transmitted when it is determined that the user has agreed in advance to the terms of use on the terminal apparatus, to the server apparatus via the communication interface within the limited period only.

[Appendix 8] The information processing apparatus according to any one of appendices 2 to 7, wherein

the agreement information is information indicating whether the user has agreed in advance to the terms of use on the terminal apparatus, has not agreed to the terms of use on the terminal apparatus, or has expressed in advance an intention to disagree to the terms of use on the terminal apparatus, and

the controller is configured, upon determining, based on the agreement information, that the user has expressed in advance the intention on the terminal apparatus, not to ask the user whether to temporarily agree to the terms of use.

[Appendix 9] The information processing apparatus according to any one of appendices 2 to 8, wherein the limited period is a period until an ignition of the vehicle is turned off.

[Appendix 10] The information processing apparatus according to any one of appendices 2 to 8, wherein the limited period is a period corresponding to one trip of the vehicle.

[Appendix 11] A system comprising:

the information processing apparatus according to any one of appendices 2 to 10; and

the server apparatus.

[Appendix 12] A vehicle comprising the information processing apparatus according to any one of appendices 2 to 10.

[Appendix 13] A program configured to cause a computer to function as the information processing apparatus according to any one of appendices 2 to 10.

[Appendix 14] An agreement confirmation method comprising:

receiving, via a network from a server apparatus, agreement information indicating whether a user on board a vehicle has agreed in advance to terms of use on a terminal apparatus associated with the user;

upon determining, based on the received agreement information, that the user has not agreed to the terms of use on the terminal apparatus, asking the user whether to temporarily agree to the terms of use, via an output device mounted in the vehicle; and

upon acquiring, from the user via an input device mounted in the vehicle, a response indicating temporary agreement to the terms of use, transmitting data collected in the vehicle to the server apparatus via the network within a limited period only.

[Appendix 15] The agreement confirmation method according to appendix 14, comprising, upon acquiring, via the input device along with the response, permission information indicating a type of data for which external use is temporarily permitted by the user, transmitting the type of data that is collected in the vehicle and that is indicated by the permission information, to the server apparatus via the network within the limited period only.

[Appendix 16] The agreement confirmation method according to appendix 14 or 15, further comprising, upon determining, based on the agreement information, that the user has agreed in advance to the terms of use on the terminal apparatus, transmitting data collected in the vehicle to the server apparatus via the network, regardless of whether it is within the limited period.

[Appendix 17] The agreement confirmation method according to appendix 16, wherein

the agreement information includes permission information indicating a type of data for which external use is permitted in advance on the terminal apparatus by the user, and

the agreement confirmation method comprises, upon determining that the user has agreed in advance to the terms of use on the terminal apparatus, transmitting the type of data that is collected in the vehicle and that is indicated by the permission information, to the server apparatus via the network, regardless of whether it is within the limited period.

[Appendix 18] The agreement confirmation method according to appendix 17, further comprising:

upon determining that the user has agreed in advance to the terms of use on the terminal apparatus, asking the user via the output device whether to temporarily permit external use of data other than the type indicated by the permission information; and

upon acquiring, from the user via the input device, a response indicating temporary permission of external use of data other than the type indicated by the permission information, transmitting data that is collected in the vehicle and that is of a type other than the type indicated by the permission information, to the server apparatus via the network within the limited period only.

[Appendix 19] The agreement confirmation method according to any one of appendices 16 to 18, comprising, upon determining that the user has not agreed to the terms of use on the terminal apparatus and upon acquiring the response from the user, transmitting data that is collected in the vehicle and that is of a more limited type than the data to be transmitted when it is determined that the user has agreed in advance to the terms of use on the terminal apparatus, to the server apparatus via the network within the limited period only.

[Appendix 20] The agreement confirmation method according to any one of appendices 14 to 19, wherein

the agreement information is information indicating whether the user has agreed in advance to the terms of use on the terminal apparatus, has not agreed to the terms of use on the terminal apparatus, or has expressed in advance an intention to disagree to the terms of use on the terminal apparatus, and

the agreement confirmation method comprises, upon determining, based on the agreement information, that the user has expressed in advance the intention on the terminal apparatus, not asking the user whether to temporarily agree to the terms of use.

1. An information processing apparatus comprising:
a communication interface configured to communicate with a server apparatus; and
a controller configured to:
upon authenticating a user on board a vehicle via an input device mounted in the vehicle, receive, via the communication interface from the server apparatus, agreement information indicating whether the user has agreed in advance to terms of use on a terminal apparatus associated with the user;
upon determining, based on the received agreement information, that the user has not agreed to the terms of use on the terminal apparatus, output a screen or audio asking the user whether to temporarily agree to the terms of use, via an output device mounted in the vehicle; and
upon acquiring, from the user via the input device, a response indicating temporary agreement to the terms of use, start monitoring a signal output from an ignition sensor mounted in the vehicle, collect one or more types of data among three types of data of images, audio, and vehicle position acquired via a camera, a microphone, and a positioning device mounted in the vehicle, respectively, until detecting that an ignition of the vehicle has been turned off, and transmit the one or more types of data in real-time to the server apparatus via the communication interface.

2. An information processing apparatus comprising:
a communication interface configured to communicate with a server apparatus; and
a controller configured to:
receive, via the communication interface from the server apparatus, agreement information indicating whether a user on board a vehicle has agreed in advance to terms of use on a terminal apparatus associated with the user;
upon determining, based on the received agreement information, that the user has not agreed to the terms of use on the terminal apparatus, ask the user whether to temporarily agree to the terms of use, via an output device mounted in the vehicle; and
upon acquiring, from the user via an input device mounted in the vehicle, a response indicating temporary agreement to the terms of use, transmit data collected in the vehicle to the server apparatus via the communication interface within a limited period only.

3. The information processing apparatus according to claim 2, wherein the controller is configured to, upon acquiring, via the input device along with the response, permission information indicating a type of data for which external use is temporarily permitted by the user, transmit the type of data that is collected in the vehicle and that is indicated by the permission information, to the server apparatus via the communication interface within the limited period only.

4. The information processing apparatus according to claim 2, wherein the controller is configured to, upon determining, based on the agreement information, that the user has agreed in advance to the terms of use on the terminal apparatus, transmit data collected in the vehicle to the server apparatus via the communication interface, regardless of whether it is within the limited period.

5. The information processing apparatus according to claim 4, wherein
the agreement information includes permission information indicating a type of data for which external use is permitted in advance on the terminal apparatus by the user, and
the controller is configured to, upon determining that the user has agreed in advance to the terms of use on the terminal apparatus, transmit the type of data that is collected in the vehicle and that is indicated by the permission information, to the server apparatus via the communication interface, regardless of whether it is within the limited period.

6. The information processing apparatus according to claim 5, wherein the controller is configured to:
upon determining that the user has agreed in advance to the terms of use on the terminal apparatus, ask the user via the output device whether to temporarily permit external use of data other than the type indicated by the permission information; and
upon acquiring, from the user via the input device, a response indicating temporary permission of external use of data other than the type indicated by the permission information, transmit data that is collected in the vehicle and that is of a type other than the type indicated by the permission information, to the server apparatus via the communication interface within the limited period only.

7. The information processing apparatus according to claim 4, wherein the controller is configured to, upon determining that the user has not agreed to the terms of use on the terminal apparatus and upon acquiring the response from the user, transmit data that is collected in the vehicle and that is of a more limited type than the data to be transmitted when it is determined that the user has agreed in advance to the terms of use on the terminal apparatus, to the server apparatus via the communication interface within the limited period only.

8. The information processing apparatus according to claim 2, wherein
the agreement information is information indicating whether the user has agreed in advance to the terms of use on the terminal apparatus, has not agreed to the terms of use on the terminal apparatus, or has expressed in advance an intention to disagree to the terms of use on the terminal apparatus, and
the controller is configured, upon determining, based on the agreement information, that the user has expressed in advance the intention on the terminal apparatus, not to ask the user whether to temporarily agree to the terms of use.

9. The information processing apparatus according to claim 2, wherein the limited period is a period until an ignition of the vehicle is turned off.

10. The information processing apparatus according to claim 2, wherein the limited period is a period corresponding to one trip of the vehicle.

11. A system comprising:
the information processing apparatus according to claim 2; and
the server apparatus.

12. A vehicle comprising the information processing apparatus according to claim 2.

13. A non-transitory computer readable medium storing a program configured to cause a computer to function as the information processing apparatus according to claim 2.

14. An agreement confirmation method comprising:
receiving, via a network from a server apparatus, agreement information indicating whether a user on board a vehicle has agreed in advance to terms of use on a terminal apparatus associated with the user;
upon determining, based on the received agreement information, that the user has not agreed to the terms of use on the terminal apparatus, asking the user whether to temporarily agree to the terms of use, via an output device mounted in the vehicle; and
upon acquiring, from the user via an input device mounted in the vehicle, a response indicating temporary agreement to the terms of use, transmitting data collected in the vehicle to the server apparatus via the network within a limited period only.

15. The agreement confirmation method according to claim 14, comprising, upon acquiring, via the input device along with the response, permission information indicating a type of data for which external use is temporarily permitted by the user, transmitting the type of data that is collected in the vehicle and that is indicated by the permission information, to the server apparatus via the network within the limited period only.

16. The agreement confirmation method according to claim 14, further comprising, upon determining, based on the agreement information, that the user has agreed in advance to the terms of use on the terminal apparatus, transmitting data collected in the vehicle to the server apparatus via the network, regardless of whether it is within the limited period.

17. The agreement confirmation method according to claim 16, wherein
the agreement information includes permission information indicating a type of data for which external use is permitted in advance on the terminal apparatus by the user, and
the agreement confirmation method comprises, upon determining that the user has agreed in advance to the terms of use on the terminal apparatus, transmitting the type of data that is collected in the vehicle and that is indicated by the permission information, to the server apparatus via the network, regardless of whether it is within the limited period.

18. The agreement confirmation method according to claim 17, further comprising:
upon determining that the user has agreed in advance to the terms of use on the terminal apparatus, asking the user via the output device whether to temporarily permit external use of data other than the type indicated by the permission information; and
upon acquiring, from the user via the input device, a response indicating temporary permission of external use of data other than the type indicated by the permission information, transmitting data that is collected in the vehicle and that is of a type other than the type indicated by the permission information, to the server apparatus via the network within the limited period only.

19. The agreement confirmation method according to claim 16, comprising, upon determining that the user has not agreed to the terms of use on the terminal apparatus and upon acquiring the response from the user, transmitting data that is collected in the vehicle and that is of a more limited type than the data to be transmitted when it is determined that the user has agreed in advance to the terms of use on the terminal apparatus, to the server apparatus via the network within the limited period only.

20. The agreement confirmation method according to claim 14, wherein
the agreement information is information indicating whether the user has agreed in advance to the terms of use on the terminal apparatus, has not agreed to the terms of use on the terminal apparatus, or has expressed in advance an intention to disagree to the terms of use on the terminal apparatus, and
the agreement confirmation method comprises, upon determining, based on the agreement information, that the user has expressed in advance the intention on the terminal apparatus, not asking the user whether to temporarily agree to the terms of use.
